(19) United States
(12) Patent Application Publication
(10) Pub. No.: US 2002/0104852 A1
(43) Pub. Date: Aug. 8, 2002

(54) Dispensing closure with tamper-evident sleeve

(76) Inventors: Joseph W. Staniszewski, Rockford, IL (US); David S. Pozgay, Chicago, IL (US); Cori M. Blomdahl, Muskego, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/086,234

(22) Filed: Feb. 27, 2002

Related U.S. Application Data
(63) Continuation of application No. 09/696,681, filed on Oct. 25, 2000, now abandoned.

(51) Int. Cl. B67B 5/00

(52) U.S. Cl. 222/153.07

(57) ABSTRACT

A closure structure for a container includes a closure body, a cooperating lid and a surrounding tamper-evident sleeve. The closure body has an end wall having a dispensing orifice, and an annular sidewall depending from the end wall and having internal threads engageable to external threads of the container. The closure lid is movable to cover the dispensing orifice in a closed position and movable away from said closed position to uncover the dispensing orifice. The tamper-evident sleeve surrounds the closure body and has a bead engageable to a retaining element of the container located below the closure body to prevent axial upward displacement of the sleeve with respect to the container The sleeve includes a retention member overlying the lid to prevent opening movement of the lid. The sleeve includes a frangible feature arranged to be torn to remove the sleeve and disengage the retention member from over the lid to allow opening of the lid.

### CROSS REFERENCE TO RELATED APPLICATION

This application is a continuation application of pending U.S. patent application Ser. No. 09/696,681, filed Oct. 25, 2000.

### TECHNICAL FIELD

The invention relates to closures for containers. More particularly, the invention relates to dispensing closures having tamper indicating features which must be broken or torn to initially open the closure.

### BACKGROUND OF THE INVENTION AND TECHNICAL PROBLEMS POSED BY THE PRIOR ART

A variety of container closures have been developed or proposed wherein an initial opening of a lid or a dispensing spout structure provides visual evidence of such an occurrence—even after the lid or spout has been subsequently closed. U.S. Pat. Nos. 4,487,324; 4,941,592; 5,201,440 and 5,875,907 disclose closures which incorporate a locking band or tab that is attached to either the lid or the body of the closure with a plurality of frangible webs so as to initially retain the closure lid to the body in the closed position. To initially open the closure, the user must break the frangible webs by pushing or pulling on a tab or band.

While the above-mentioned closures can function well for the purposes for which they have been designed, it would be desirable to provide an improved tamper-evident closure which could be readily fabricated to associate with certain types of lids or flow control elements and which, prior to initial opening, could enhance the cosmetic appearance of the closure. It would be desirable if such a tamper-evident closure could be easily installed on a container in its tamper-indicating ready condition for eventual delivery to the consumer.

### BRIEF SUMMARY OF THE INVENTION

The closure structure of the invention provides an effective tamper-indicating feature which evidences unauthorized access or tampering with a contained product. The closure structure is cost effectively molded, assembled and installed on a container.

A first aspect of the invention comprises a closure structure for a container, the container having a container neck defining a dispensing opening. The structure includes a cap having an end wall for at least partially closing the opening of the container neck, and a surrounding tamper-evident sleeve having an annular wall sized to surround the container neck. The annular wall is engaged to the container neck below the cap. A top retention member extends radially inwardly from the annular wall over the cap end wall. The surrounding sleeve includes at least one frangible feature configured to be separated by a user, separation of the feature allowing at least partial disengagement of the surrounding sleeve from the container neck so as to provide access to the cap.

The annular wall can be engaged to the container neck by means of a retaining element extending radially outwardly from the container neck, spaced from the container neck dispensing opening, and an engagement member extending radially inwardly from the annular wall of the sleeve to be positioned beneath the retaining element to prohibit axial separation of the sleeve from the container neck. Separation of the frangible feature allows the annular wall to be spread open to disengage the engagement member from the retaining element to axially or radially remove the top retention member from over the cap.

Another aspect of the invention provides that the cap comprises a closure body and a closure lid. The closure body has an end wall defining a dispensing orifice in fluid communication with the container dispensing opening, and an annular sidewall engageable to the container neck. The closure lid has an occluding portion movable to cover the dispensing orifice in a closed position and movable away from the closed position to uncover the dispensing orifice. The tamper-evident sleeve surrounds the closure body and the lid and is engaged to the container neck below the closure body to prevent axial upward displacement of the sleeve with respect to the container neck. The sleeve includes a retention member overlying the closure lid to prevent movement of the occluding portion to uncover the dispensing orifice. The frangible feature of the sleeve is arranged to be torn to disengage the retention member from over the lid to allow the occluding portion to be moved to uncover the dispensing orifice.

Another aspect of the invention provides that the tamper-evident sleeve can be separately molded and assembled over the cap, prior to mounting the assembly on the container. To mount the assembly on the container, the cap, carrying the surrounding sleeve, is screwed or otherwise engaged to the container. The sleeve is simultaneously engaged to the container by the engagement member of the sleeve, in the form of a bead, which is snapped over a retaining element of the container neck, in the form of a ring. To facilitate screwing on of the sleeve and cap, the sleeve is provided with interior knurling or ribs which engage exterior knurling or ribs of the cap. The mutual engagement of the interior and exterior knurling or ribs ensures mutual turning of the sleeve and cap. This operation is advantageously performed in rapid fashion by a capping machine.

The tamper-evident sleeve of the invention prevents unauthorized and undetected removal or opening of a closure lid and/or a closure body from a container. According to the exemplary embodiment, the sleeve prevents undetected opening of the lid from the body and prevents undetected removal of the body from the container neck.

Numerous other advantages and features of the present invention will become readily apparent from the following detailed description of the invention, from the claims, and from the accompanying drawings.

### BRIEF DESCRIPTION OF THE DRAWINGS

The accompanying drawings form part of the specification, and like numerals are employed to designate like parts throughout the same.

FIG. 1 is a perspective view of a closure structure of the present invention, including a closure assembly surrounded by a tamper-evident sleeve, mounted or installed on a container;

FIG. 2 is a perspective view of the closure structure of FIG. 1 with a tamper-indicating tear strip of the tamper-evident sleeve removed;

FIG. 3 is a perspective view of the tamper-evident sleeve of FIG. 1, separate from the closure assembly;

FIG. 4 is a sectional view taken generally through line 4-4 of FIG. 1; and

FIG. 5 is a perspective view of an alternate embodiment tamper-evident sleeve, separate from the closure assembly.

### DETAILED DESCRIPTION

While this invention is susceptible of embodiment in many different forms, this specification and the accompanying drawings disclose only some specific forms as examples of the invention. The invention is not intended to be limited to the embodiments so described, however. The scope of the invention is pointed out in the appended claims.

For ease of description, figures illustrating the invention show a dispensing system in the typical orientation that it would have at the top of a container when the container is stored upright on its base, and terms such as upper, lower, horizontal, etc., are used with reference to this position. It will be understood, however, that the dispensing system of this invention may be manufactured, stored, transported, used, and sold in an orientation other than the position described.

The dispensing system of this invention is suitable for use with a variety of conventional or special containers having various designs, the details of which, although not illustrated or described, would be apparent to those having skill in the art and an understanding of such containers. The container per se described herein forms no part of some aspects of the invention and therefore is not intended to limit the present invention. It will also be understood by those of ordinary skill that novel and non-obvious inventive aspects are embodied in the described exemplary closure systems alone.

An exemplary embodiment of a closure structure 30 according to the invention is illustrated in FIGS. 1-4. The closure structure 30 is adapted to engage a container neck 32. The closure structure 30 includes an outer, surrounding tamper-evident sleeve 36 and an inner cap 40. The sleeve 36 is configured to prevent access to the contents of the container until the sleeve is disengaged from the container neck, preferably by removal of the sleeve from the container neck.

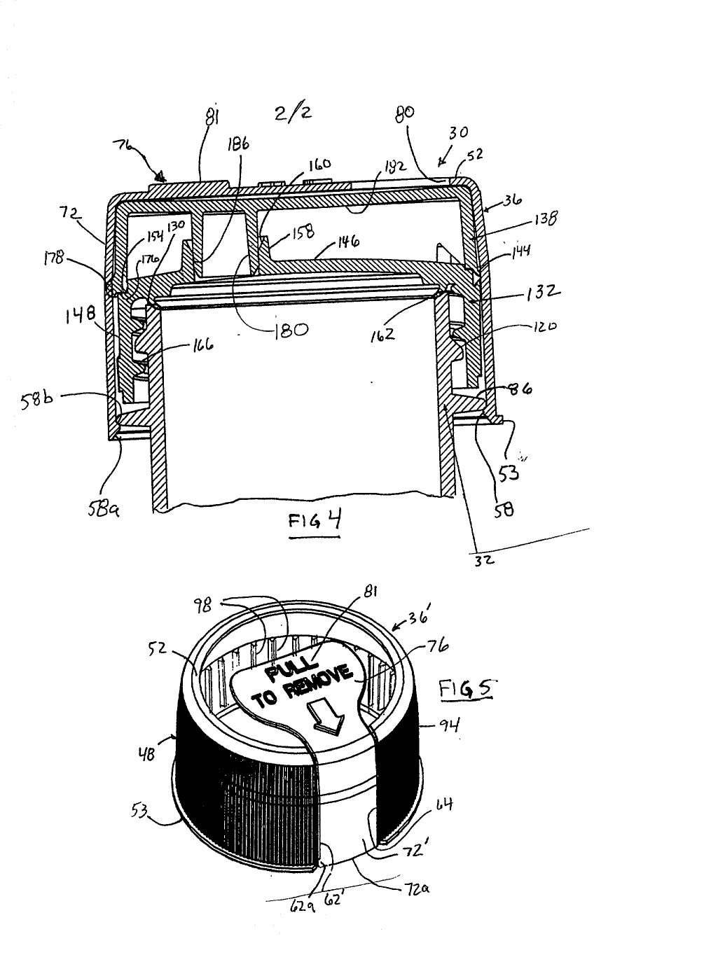

The tamper-evident sleeve 36 surrounds the cap 40 and the container neck 32. The sleeve 36 includes an annular sidewall 48, a top retention member in the form of a partially annular lip 52 extending radially inwardly from the sidewall 48, and a bottom engagement member in the form of an annular bead 58 (shown in FIG. 4), extending radially inwardly from the sidewall 48. An external, partially annular flange 53 extends outwardly from a bottom of the annular sidewall 48. The annular flange 53 increases the hoop rigidity of the annular sidewall 48 to prevent prying off of the sleeve after its initial installation on the cap 40.

The annular sidewall 48 includes a first frangible feature in the form of a first line of weakness 62, and a second frangible feature in the form of a second line of weakness 64. The first and second lines of weakness define a tear strip 72 therebetween. A pull tab 76 extends perpendicularly (radially) from tear strip 72 into a central region 80 of the sleeve. The pull tab 76 can carry molded or other indicia 81 giving opening instructions or other information.

The frangible lines 62, 64 can be made frangible in a number of ways, including forming the lines with a reduced thickness, forming the lines as a through cut with intermittently arranged bridging webs, forming the lines as a plurality of perforations, etc.

The lines need not be linear, but can be curved or inflected. The two lines need not be parallel. It is also encompassed by the invention that a single frangible line is used to separate the annular wall.

For the cap 40 to be initially opened, the sleeve must be removed. The tab 76 is grasped and the tear-off strip is pulled outwardly and downwardly to tear the sleeve along the lines of weakness 62, 64. After the tear off strip 72 is removed the sleeve can be forcibly opened up or spread open to be removed from the container neck. The external, partially annular flange 53 provides rigidity to stabilize the sleeve during tear-removal of the tear-off strip 72.

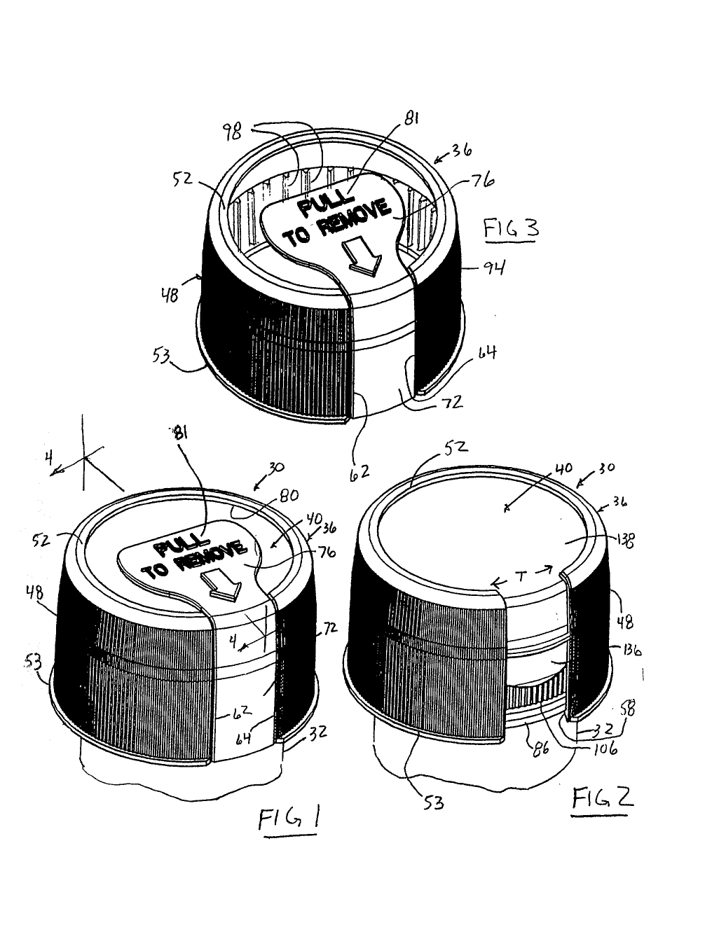

FIG. 2 illustrates the tamper-indicating sleeve 36 having been torn to be removed from the container neck 32. With the tear strip 72 missing, the annular sidewall 48 can be spread sufficiently in the tangential direction T to be removed axially, or radially, over a container neck retaining element 86 (described below), from the container neck 32.

FIG. 3 illustrates the tamper-indicating sleeve 36 in isolation. The sleeve can include knurling or ribs 94 on an outside surface for gripping by capping machinery to screw on the closure structure to a container neck. The sleeve can also include internal knurling or ribs 98 on an inside surface thereof. The internal knurling or ribs 98 engage external knurling or ribs 106 on the cap 40 (shown in FIG. 2), so that the torque applied by the capping machine to the closure structure 30 is transferred through the sleeve 36 to the cap 40 for screwing the closure structure on the container neck 32.

As can be seen in FIG. 4, the closure structure 30 is engaged to the container neck 32. The container neck 32 includes an external thread formation 120 and the retaining element 86, in the form of a flange or a ring. The container neck 32 also includes a top container finish or annular sealing surface 130.

The cap 40 of the closure structure includes a closure body 132 and a lid 138 connected together by a hinge 144. The closure body 132 includes a deck 146 and a depending, hollow, generally cylindrical skirt 148. An annular shoulder 154 is defined on the top of the skirt 148, surrounding the deck 146. The closure structure also includes a spout 158 extending upwardly from the deck 146. A compressible seal 162 extends from the bottom surface of the deck. This seal can be a “crab's claw” seal.

The interior of the skirt 148 also defines an internal, female thread 166. The skirt 148 is adapted to receive and threadingly engage the upper end of the container neck 32. The skirt thread 166 is adapted to matingly engage the thread 120 of the container neck 32. Full engagement of the threads 120, 166 causes the top sealing surface 130 of the container neck to compress the cap body compressible seal 162 to form a seal between the closure structure 30 and the container neck 32. The top sealing surface 130 is typically flat and interferes with the seal 162, as shown schematically in FIG. 4 by the overlapping cross sections of these parts in their relaxed states.

As an alternative to threading, the closure skirt 148 could be provided with some other container connecting means, such as a snap-fit bead or groove (not illustrated) in place of the thread 166 for engaging a container groove or bead (not illustrated), respectively, in the container neck.

The tamper-evident sleeve of the exemplary embodiment of FIGS. 1-4 prevents unauthorized, undetected opening of the lid from the body and/or the unauthorized, undetected removal of the body from the container neck. In an alternate embodiment where tamper-evidency of only the lid alone is necessary, the closure body 132 could be permanently attached to the container by means of induction melting, ultrasonic melting, gluing, or the like, depending on materials used for the closure body 132 and container. The closure body 132 could also be formed as a unitary part, or extension, of the container.

The closure body skirt 148 may have any suitable configuration. The container could have an upwardly projecting “neck” or other portion for being received within the particular configuration of the closure body 132, and the main part of the container may have a same or a different cross-sectional shape than the container neck and closure body skirt 148. In this regard, “neck” only refers to that portion of the container that receives the closure structure, and is not limited to a portion which is more narrow than adjoining portions of the container, or the main body of the container. For example, the term “neck” also encompasses the closure-structure-receiving portion of a tubular container, wherein the neck has the same diameter as the remaining portions of the container.

The closure structure 30 is adapted to be used with a container having a mouth or other opening to provide access to the container interior and to a product contained therein. The product may be, for example, a comestible product such as a food paste, jelly or jam. However, the closure structure 30 could also be used with many other materials, including, but not limited to, relatively low or high viscosity liquids, particulates, etc. as constituting a food product, a personal care product, an industrial or household cleaning product, or other chemical compositions (e.g., compositions for use in activities involving manufacturing, commercial or household maintenance, construction, agriculture, etc.).

The container with which the closure structure may be used would typically be a squeezable container having a flexible wall or walls which can be grasped by the user and squeezed or compressed to increase the internal pressure within the container so as to force the product out of the container and through the closure structure 30. The container wall typically has sufficient, inherent resiliency so that when the squeezing forces are removed, the container wall returns to its normal, unstressed shape. Such a squeezable wall container is preferred in many applications but may not be necessary for preferred in other applications. For example, in some applications it may be desirable to employ a generally rigid container and pressurize the container interior at selected times with a piston or other pressurizing system.

The lid 138 is preferably hingedly connected to the closure body 132, with the hinge 144 preferably being a snap-action hinge. Such a hinge is disclosed in the U.S. Pat. No. 5,642,824, the disclosure of which is incorporated herein by reference thereto. In an alternate embodiment, the lid 138 need not be connected with a snap-action hinge. A floppy hinge may be used instead. Further, in another embodiment (not illustrated), the hinge 144 may be omitted entirely, and the lid 138 can be completely separate, and completely removable, from the closure body. In some applications, the lid 138 be omitted altogether.

The lid 138 includes a sidewall or lid skirt 172 (FIG. 4) from which the hinge 144 extends to the body 132. The lid skirt 172 has a lid seating surface 176. When the lid 138 is closed, the lid seating surface 176 engages the annular shoulder 154 defined on the closure body 132 at the top of the closure body sidewall 148. The lid 138 includes a lifting tab 178 extending radially outwardly on a front side of the lid 138. The lifting tab 178 is used for opening the lid after the sleeve is removed. The lifting tab 178 and the sleeve 36 are sized and shaped to resiliently interfere, as schematically indicated in FIG. 4 by the overlapping cross sections of the two parts in their relaxed state. The interference acts to retain the closure body 132 and lid 138 within the sleeve 36 prior to assembly on the container neck 32. The interference also acts to ensure that the closure body 132 rotates with the sleeve during installation of the closure structure 30 on the container neck 32. This is especially important if the interior knurling or ribs 98 (shown in FIG. 3) are not used.

The lid 138 includes an orifice sealing member or “spud” 180 which extends from a lid end wall 182 and which is adapted to sealingly engage a peripheral surface 186 of the orifice 160 when the lid 138 is pivoted from the open position to a closed position. As will be recognized, the orifice sealing member 180 is of a complementary shape relative to the shape of the dispensing orifice 160. The lid end wall 182 functions as an occluding portion which is movable to (1) a closed position to cover the dispensing orifice, and (2) an open position away from the closed position to uncover the dispensing orifice.

In the tamper-indicating ready position illustrated in FIGS. 1 and 4, the retention member 52 overlies the end wall 182 of the closure lid 138 and prevents the lifting thereof. The annular bead 58 underlies the retaining element 86 of the container neck 32 to prevent removal of the sleeve 36 in an upward direction. In this regard, the annular bead 58 includes a gradually sloping leading side 58a and a steeply sloping retention side 58b. The gradually sloping leading side 58a allows the annular bead 58 to resiliently pass over the retaining element 86 during initial installation on the container neck. The steeply sloping retention side 58b prevents the unauthorized and undetected removal of the sleeve from the container neck.

For the closure lid to be initially opened, the sleeve 36 must be removed. The tab 76 is grasped and the tear-off strip is pulled outwardly and downwardly to tear the sleeve along the lines of weakness 62, 64. After the tear off strip 72 is removed, the sleeve can be opened up to be removed from the container neck. Thereafter, to dispense material from the container, the lid 138 is pivoted about the hinge 144 until the spud 180 is removed from the orifice 160.

The closure structure 30 is advantageously configured to be easily and cost effectively installed onto a container neck 32. The closure structure 30 as a unit is mounted onto the container neck 32 and turned to advance the closure threads 166 on the container threads 120. Additionally, as the threads 166 advance, the bead 58 passes over the retaining element 86 to be engaged as shown in FIG. 4. In this manner, the entire closure structure 30, including the tamper-evident sleeve 36 and cap 40, can be installed by the capping machine in a single step.

FIG. 5 illustrates an alternate embodiment tamper-evident sleeve 36′ which includes a modified tear-off strip 72′. The modified tear-off strip 72′ is defined between the prior described line of weakness 64 and a modified line of weakness 62′. The modified line of weakness 62′ stops short of a bottom edge 72a of the strip to form an attachment web 62a between the edge 72a and the line of weakness 62′. Thus, by pulling the tab 76 down, the tear-off strip can be completely separated from the sleeve at the line 64 but only partially separated from the sleeve at the line 62′. The advantage of this arrangement is that rather than two scrap pieces being formed by the sleeve, only a single scrap piece, including the sleeve with attached strip 72 and tab 76, is formed.

It will be readily apparent from the foregoing detailed description of the invention and from the illustrations thereof that numerous variations and modifications may be effected without departing from the true spirit and scope of the novel concepts or principles of this invention. For example, although the closure assembly of the invention is exemplified by a threaded engagement with the container, the invention contemplates other fastening techniques and implements for securing the closure assembly to the container. Another fastening might incorporate a friction fit facilitated by a closure assembly having a skirt with an inside diameter sized to provide a sliding or telescoping engagement with a smooth, threadless container finish. In such an embodiment, the fitment and closure body would be provided with abutment surfaces, for example, a bayonet type interlock or fastening implement, which permit installation of the closure assembly on the container, but which may be configured, for example, by relative rotation of the closure body and container, to restrict upward movement of the closure body relative to the container.

What is claimed is:

1. A closure structure for a container, the container having a container neck defining a dispensing opening, an external thread formation formed on said container neck, and a retaining element extending radially from said container neck spaced from said container neck dispensing opening, the structure comprising:
a closure body having an end wall defining a dispensing orifice in fluid communication with said dispensing opening, and an annular sidewall depending from said end wall and having an internal thread formation engageable to the external thread formation on the container neck;
a closure lid having an occluding portion movable to cover said dispensing orifice in a closed position and movable away from said closed position to uncover said dispensing orifice; and
a tamper-evident sleeve surrounding said closure body and having an engagement member underlying said retaining element of said container neck below said closure body to prevent axial upward displacement of said sleeve with respect to said container neck, and having a retention member overlying said closure lid to prevent movement of said occluding portion to uncover said dispensing orifice; said sleeve including a frangible feature arranged to be torn to allow removal of said retention member from over said lid to allow said occluding portion to be moved to uncover said dispensing orifice.

2. The closure structure according to claim 1, wherein said frangible feature comprises a first frangible line arranged substantially in an axial orientation, and extending throughout a height of said annular wall, and a second frangible line arranged substantially in an axial orientation and extending throughout said height of said annular wall, and defining with said first frangible line a tear-off strip.

3. The closure structure according to claim 2, comprising a tab portion connected to said tear-off strip, said tab portion extending radially inwardly of said annular wall.

4. The closure structure according to claim 1, wherein said retaining element comprises a ring unitary with said container neck.

5. The closure structure according to claim 1, wherein said engagement member comprises an annular bead extending radially inwardly from said annular wall.

6. The closure structure according to claim 1, wherein said container has a body portion, and said neck extends from said body portion in the same or different cross sectional shape and with the same or different cross sectional dimension.

7. A closure structure for a container, the container having a container neck defining a dispensing opening, the structure comprising:
a cap having an end wall for at least partially closing said opening of said container neck;
a surrounding sleeve having an annular wall sized to surround said container neck, a top retention member extending radially inwardly from said annular wall over said end wall, and said sleeve engaged to said container neck below said cap to prohibit axial separation of said surrounding sleeve from said container neck;
said surrounding sleeve including at least one frangible feature configured to be separated by a user, separation of said feature allowing at least partial disengagement of said engagement element from said retaining element and removal of said surrounding sleeve from said container neck.

8. The closure structure according to claim 7, wherein said frangible feature comprises a first frangible line arranged substantially in an axial orientation, and extending throughout a height of said annular wall, and a second frangible line arranged substantially in an axial orientation and extending throughout said height of said annular wall, and defining with said first frangible line a tear-off strip.

9. The closure structure according to claim 7, wherein said cap comprises a closure body adapted to fit onto said container neck and defining a dispensing orifice in fluid communication with said dispensing opening of said container neck, and said cap comprises a closure lid having a lid portion arranged to be moved between a closed position to occlude said dispensing orifice and an open position spaced from said dispensing orifice.

10. The closure structure according to claim 7, wherein said cap comprises a portion configured to selectively occlude said dispensing opening of said container neck.

11. The closure structure according to claim 7, wherein the container neck includes a retaining element extending radially outwardly therefrom, and said sleeve includes an engagement member extending radially inwardly therefrom to underlie said retaining element.

12. The closure structure according to claim 7, wherein said container neck comprises a first thread formation between said dispensing opening and said retaining element, and said closure body comprises a second thread formation engageable with said first thread formation to hold said closure body onto said container neck in sealed relationship therewith.

13. The closure structure according to claim 7, wherein said container has a body portion, and said neck extends from said body portion in the same or different cross sectional shape and with the same or different cross sectional dimension.

14. A closure structure for a container, the container having a container neck defining a dispensing opening, the structure comprising:
a closure body having an end wall defining a dispensing orifice in fluid communication with said dispensing opening, and an annular sidewall engageable to the container neck;
a closure lid having an occluding portion movable to cover said dispensing orifice in a closed position and movable away from said closed position to uncover said dispensing orifice;
a tamper-evident sleeve surrounding said closure body and said lid and engaged to said container neck below said closure body to prevent axial upward displacement of said sleeve with respect to said container neck, and having a retention member overlying said closure lid to prevent movement of said occluding portion to uncover said dispensing orifice; said sleeve including a frangible feature arranged to be separated to disengage said retention member from over said lid to allow said occluding portion to be moved to uncover said dispensing orifice.

15. The closure structure according to claim 14, wherein said frangible feature comprises a first frangible line arranged substantially in an axial orientation, and extending throughout a height of said annular wall, and a second frangible line arranged substantially in an axial orientation and extending throughout a height of said annular wall, and defining with said first frangible line a tear-off strip.

16. The closure structure according to claim 14, wherein said cap comprises a closure body adapted to fit onto said container neck and defining a dispensing orifice in fluid communication with said dispensing opening of said container neck, and a closure lid having a lid portion arranged to be moved between a closed position to occlude said dispensing orifice and an open position spaced from said dispensing orifice.

17. The closure structure according to claim 14, wherein said cap comprises a portion configured to selectively occlude said dispensing opening of said container neck.

18. The closure structure according to claim 14, wherein the container neck includes a retaining element extending radially outwardly therefrom, and said sleeve includes an engagement member extending radially inwardly therefrom to underlie said retaining element.

19. The closure structure according to claim 18, wherein said container neck comprises a first thread formation between said dispensing opening and said retaining element, and said closure body comprises a second thread formation engageable with said first thread formation to hold said closure body onto said container neck in sealed relationship therewith.

20. The closure structure according to claim 18, wherein said retaining element comprises a radially outwardly directed ring and said engagement member comprises a radially inwardly directed bead.

21. The closure structure according to claim 14, wherein said container has a body portion, and said neck extends from said body in the same or different cross sectional shape and with the same or different cross sectional dimension.
